(19) United States
(12) Patent Application Publication
(10) Pub. No.: US 2026/0180790 A1
(43) Pub. Date: Jun. 25, 2026

(54) MULTI-ALGORITHM BOOTSTRAPPING

(71) Applicant: ARQIT LIMITED, London (GB)

(72) Inventors: Stephen Holmes, London (GB); Michael Murphy, London (GB); David Webb, London (GB)

(21) Appl. No.: 19/127,672

(22) PCT Filed: Dec. 11, 2023
(86) PCT No.: PCT/GB2023/053186

§ 371 Date: May 6, 2025

(30) Foreign Application Priority Data
Dec. 19, 2022 (GB) 2219179.5

(51) Int. Cl. H04L 9/08; H04L 9/16

(52) U.S. Cl. CPC H04L 9/0838; H04L 9/0822; H04L 9/085; H04L 9/0852; H04L 9/16

(57) ABSTRACT

Provided here is a computer-implemented method, system and computing device for agreeing a final symmetric key between a first party and a second party, wherein the first party is configured to communicate with the second party, the method comprising: retrieving a plurality of key exchange algorithms or key encapsulation mechanisms wherein the plurality of key exchange algorithms or key encapsulation mechanisms are each different; agreeing a set of keys using the plurality of key exchange algorithms or key encapsulation mechanisms; using the agreed set of keys to obtain a final symmetric key, according to a combination scheme that specifies how each key of the set of keys is to be used to obtain the final symmetric key; and storing the final symmetric key at the first and second party.

### TECHNICAL FIELD

This application relates to a method, device and system for establishing a symmetric encryption key on a device for use in either underpinning a system for securely encrypting data, or for use for securely encrypting data, and in particular, encryption including the use of a plurality of encryption algorithms and/or methods, used in combination to improve overall security.

### BACKGROUND

Encryption has been used in many ways to protect sensitive information. Encryption is used to protect data stored on computers and other storage devices, as well as data in transit over networks and/or between end devices. There are many different methods of encrypting data, each with their own advantages and disadvantages.

Encryption of data may be performed by means of symmetric key encryption, whereby the same cryptographic keys are used both for encryption and decryption. The keys represent a shared secret between two or more parties that can be used to maintain a private information link. In symmetric key encryption, the two or more parties must thus have access to the same keys.

Alternatively, encryption may be performed by means of asymmetric key encryption, whereby encryption and decryption is performed with a pair of keys, each pair including a public key (which may be known to others and is used to encrypt data) and a private key (which may not be known by anyone except the owner and is used to decrypt data). The public key can be openly distributed without compromising security, whereas the private key must be kept private to maintain security.

A popular asymmetric key encryption method is the Diffie-Hellman key exchange protocol. Diffie-Hellman key exchange establishes a shared secret between two parties that can be used for secret communication for exchanging data over a public network. The security of the protocol depends upon the difficulty of solving the Diffie-Hellman problem, which is given integers q (the order of a group), g (a generator of that group), g^{a} mod q (or g^{b} mod q) to find the value of g^{ab} mod q. This problem has been proven to be equivalent to the Discrete logarithm problem, i.e. given integers q, g and g^{a} mod q, find the smallest positive integer value a. The protocol has been strengthened to address ‘man in the middle’ attacks by adding authentication by variants including the Needham-Schroeder and MQV/HMQV protocols.

However, the advent of quantum computers poses a threat to such algorithms for key exchange and thus a threat to data encrypted by the key agreed through such algorithms. The problem with asymmetric cryptographic algorithms such as Diffie-Hellman is that their security relies on one of three hard mathematical problems: the discrete logarithm problem, the integer factorization problem, or the elliptic-curve discrete logarithm problem. It is probable that all of these algorithms could be solved in a reasonable amount of time by a sufficiently powerful quantum computer capable of running Shor's algorithm. Classical computers would take much longer to solve such algorithms.

Symmetric cryptographic algorithms are in comparison, relatively secure against such attacks, from a quantum computer. However, Grover's algorithm speeds up attacks against symmetric algorithms by reducing the strength by a square root factor. Doubling the key size is one way of slowing down or negating these attacks, but is computationally inefficient.

Post-quantum cryptography refers to cryptographic post-quantum algorithms (PQAs) that are thought, but not necessarily proven, to be more secure against a cryptanalytic attack by a quantum computer. PQAs that enable key-exchange between parties are focused predominantly on approaches such as: Lattice-based cryptography, Multivariate cryptography, Hash-based cryptography, Code-based cryptography, Super singular elliptic curve isogeny cryptography, and symmetric key quantum resistance. Several PQAs have however been shown to have vulnerabilities to attack from classical computers in some circumstances

There is also a trade-off in terms of memory requirements, key sizes and computational requirements as well as security between the different algorithms used. For example, Classic McEliece key sizes are upwards of 1.5 MB and are believed to be the most secure, whereas KYBER has much smaller key sizes but may not be as secure.

The use of many different PQAs with such large key sizes would thus be unfeasible for establishing a connection using Transport Layer Security (TLS), for example, where a key exchange of hundreds of milliseconds is required.

It has however been appreciated that multiple algorithms can be beneficial in providing additional protection against attacks from quantum computers, when used in a singular instance to establish a bootstrap key for use in future sessions.

### SUMMARY OF INVENTION

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect, the present disclosure provides a computer-implemented method of agreeing a final symmetric key between a first party and a second party, wherein the first party is configured to communicate with the second party, the method comprising: retrieving a plurality of key exchange algorithms or key encapsulation mechanisms wherein the plurality of key exchange algorithms or key encapsulation mechanisms are each different; agreeing a set of keys using the plurality of key exchange algorithms or key encapsulation mechanisms; using the agreed set of keys to obtain a final symmetric key, according to a combination scheme that specifies how each key of the set of keys is to be used to obtain the final symmetric key; and storing the final symmetric key at the first and second party.

The combination scheme may be Shamir's Secret Sharing scheme, SSS, such that obtaining the final symmetric key comprises, at the first party: generating the final symmetric key; splitting the final symmetric key into a plurality of shares; encrypting each share with a key of the agreed set of keys; transmitting each encrypted share to the second party; and at the second party: decrypting each encrypted share with a respective key of the set of agreed keys; and combining all or some of the decrypted shares to obtain the final symmetric key.

The combination scheme may be an exclusive or scheme, XOR, such that the method comprises: performing an XOR operation on the agreed set of keys to obtain the final symmetric key.

The combination scheme may include a sequence or series of one or more hash functions. For example, a secure hash algorithm such as a Secure Hash Algorithm 3 (SHA-3) may be used to obtain the final symmetric key.

The combination scheme may be a sequential encryption scheme, such that the method comprises: performing sequential encryption using the agreed set of keys, in a specific order, to obtain the final symmetric key.

The plurality of key exchange algorithms or key encapsulation mechanisms may include classical cryptographic algorithms.

The plurality of key exchange algorithms or key encapsulation mechanisms may include post-quantum cryptographic algorithms.

The method may further comprise retrieving a policy, wherein the policy includes information indicative of parameters to be used for obtaining the final symmetric key, the parameters including at least one of: a number of key exchange algorithms or key encapsulation mechanisms to use to obtain the final symmetric key; a type of key exchange algorithm or key encapsulation mechanism to use to generate the final symmetric key; specific algorithms or mechanisms of the plurality of key exchange algorithms or key encapsulation mechanisms to use to generate the final symmetric key; an ordering of the specific algorithms or mechanisms to use to generate the final symmetric key; a key length for generating the final symmetric key; the combination scheme to use to generate the final symmetric key; and whether the final symmetric key is to be generated in series or parallel; the method further comprising: generating the final symmetric key using the parameters included in the policy.

The method may further comprise agreeing the policy between the first and second party; or sending the policy from the first party to the second party; or sending the policy from the second party to the first party.

When the combination scheme used is SSS, the policy may comprise at least one of: a number of shares to divide the final symmetric key between; and a threshold number of shares required to reconstruct the final symmetric key.

The parameters of the policy may be set based on technical constraints of the first party and/or the second party.

The technical constraints may include at least one of: a memory availability; a measure of processing power; a time limit for performing the agreeing the set of keys and a bandwidth in a communication channel.

The plurality of key exchange algorithms may include at least two algorithms that are diverse, wherein the diverse algorithms rely on different mathematical problems or underlying concepts.

The method may further include obtaining the final symmetric key includes selecting at least the two diverse algorithms from the plurality of algorithms.

The method may further comprise: maintaining, at the first party, a database including the plurality of key exchange algorithms, wherein each key exchange algorithm in the database is associated with information indicative of the concept on which the key exchange algorithm is based; the method further comprising: retrieving, from the database, two or more key exchange algorithms based on the associated information for the two or more key exchange algorithms being diverse with respect to the concept on which they are based.

The final symmetric key may be one of a bootstrap key; an authentication key; or a data encryption key. A bootstrap key is a single use key that is used to bootstrap a system and then discarded. An authentication key could be a longer lived authentication key. A data encryption key would be used to permanently store data in an encrypted form.

In a second aspect, the present disclosure provides a system comprising: a first computer device having memory and a processor; and a second computer device having memory and a processor; wherein the first computer device and the second computer device are configured to communicate with each other, wherein the first computer device is a first party and the second computer device is a second party, and wherein the system is configured to execute the method according to the first aspect as set out above.

The first computer device may be a server and the second computer device may be a user terminal device.

In a third aspect, the present disclosure provides a computing device configured to communicate with one or more external computing devices, the computer device comprising a processor and memory, the memory having instructions stored thereon, which, when executed, cause the processor to: retrieve a plurality of key exchange algorithms or key encapsulation mechanisms, wherein the plurality of key exchange algorithms or key encapsulation mechanisms are each different; agree, with a second computing device of the one or more external computing devices, a set of keys using a plurality of key exchange algorithms or key encapsulation mechanisms; use the agreed set of keys to obtain a final symmetric key, according to a combination scheme that specifies how each key of the set of keys is to be used to obtain the final symmetric key; and store the final symmetric key to memory.

The computing device may be configured to communicate with the second computing device to agree a policy with the second computing device, wherein the policy includes information indicative of parameters to be used for generating the final symmetric key, the parameters including at least one of: a number of key exchange algorithms or key encapsulation mechanisms to use to generate the final symmetric key; a type of key exchange algorithm or key encapsulation mechanism to use to generate the final symmetric key; specific algorithms or encapsulation mechanisms of the plurality of key exchange algorithms or key encapsulation mechanisms to use to generate the final symmetric key; an ordering of the specific algorithms or encapsulation mechanisms to use to generate the final symmetric key; a key length for generating the final symmetric key; the combination scheme to use to generate the final symmetric key; and whether the final symmetric key is to be generated in series or parallel; wherein the computing device is configured to generate the final symmetric key using the parameters included in the policy.

The computing device may be configured to combine the key exchange algorithms according to a Shamir's secret sharing combination scheme.

The computing device may be configured to automatically select two or more of the plurality of key exchange algorithms based on their relative diversity in underlying concept.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of a computing device according to various embodiments;

FIG. 2 is a schematic diagram of a computer system according to various embodiments;

FIG. 3 is a flow diagram illustrating a method according to various embodiments;

FIG. 4 is a flow diagram illustrating a method according to various embodiments; and

FIG. 5 is a flow diagram illustrating a method according to various embodiments.

Common reference numerals are used throughout the figures to indicate similar features.

### DETAILED DESCRIPTION

This application relates to a method, device and system for exchanging a symmetric key between parties for use in securely encrypting data, to improve overall security of data storage and/or communication.

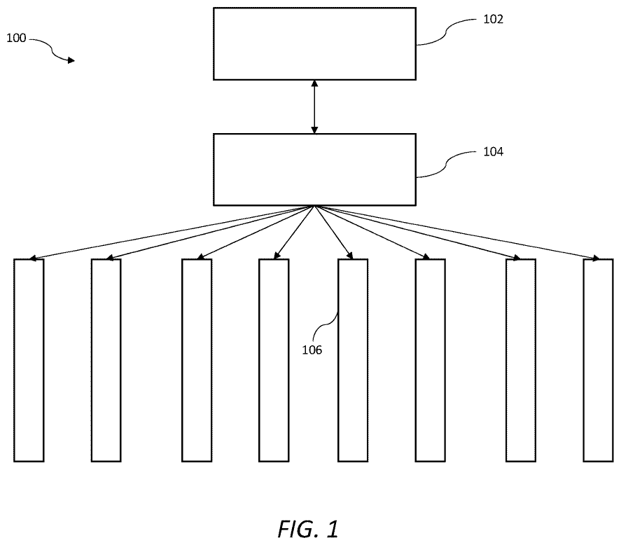

FIG. 1 shows a schematic diagram of a computing device 100 according to various embodiments. The device 100 includes a controller 102, a scheme processing module 104, and a plurality of algorithm modules 106.

The controller 102 is communicatively coupled to the scheme processing module 104, and may be communicatively coupled to the plurality of algorithm modules 106. The controller 102 is configured to control and instruct the scheme processing module 104 to utilise at least a selection of the plurality of algorithm modules 106 according to a specific combination scheme.

The scheme processing module 104 is configured to utilise at least a selection of the plurality of algorithm modules 106 according to the specific combination scheme. The combination scheme is a method in which algorithms of the algorithm modules 106 are to be used and combined for the purposes of key exchange. Such schemes are explained in detail later.

The algorithm modules 106 each comprise an algorithm such as a cryptographic algorithm or a post-quantum cryptographic algorithm, which are suitable for key exchange. Data is input to at least a selection of the algorithm modules according to the combination scheme, where it is then manipulated, modified or transformed based on the algorithm in each algorithm module.

There may be any suitable number of algorithm modules comprising any suitable number of algorithms. Although a plurality of algorithm modules 106 are illustrated in FIG. 1, it is to be understood that there may be one (or more than one) algorithm module 106 comprising a plurality of algorithms. Similarly, although the plurality of algorithm modules 106 and the scheme processing module 104 are illustrated as being physically separate in FIG. 1, these modules could form part of the same physical structure, and may for example, use the same memory device, processor and/or computing device to function. Similarly, the controller 102 may form part of the same physical structure or component as the scheme processing module 104. The controller 102 may thus be considered to be a control module.

In operation, the controller 102 instructs the scheme processing module 104 to agree a bootstrap key according to one or more parameters. The one or more parameters include one or more of the specific combination schemes to be used to agree the bootstrap key, whether the bootstrap key is to be agreed in series or parallel, the number of algorithms to be used to agree the bootstrap key, the type of algorithms to be used to agree the bootstrap key, and the actual algorithms to be used to agree the bootstrap key. The ordering of the algorithms may also be agreed if necessary, such as in the instance the key is to be agreed in series, whereby the ordering of algorithms is important.

An advantage of agreeing a bootstrap key using a plurality of algorithms is that an attacker (adversary) would have to break all algorithms in order to calculate the bootstrap key. Thus, security of the bootstrap key is improved over encryption keys that are agreed with a singular algorithm.

The bootstrap key is a symmetric authentication key, agreed between a first computing device and a second computing device, wherein one of the first or second computing devices is or includes the device 100 outlined above. The bootstrap key may also or alternatively be a data encryption key. For example, the first computing device may be the device 100, and may be a computer, mobile phone device, tablet, server, cloud-based system or the like. The second computing device may be a computer, mobile phone device, tablet, or the like.

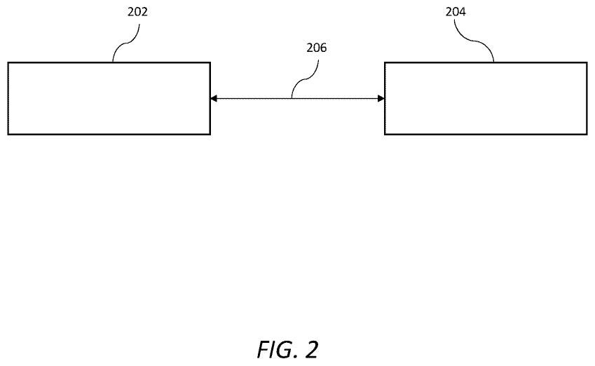

FIG. 2 is a schematic diagram showing the first computing device 202 and the second computing device 204 for which the bootstrap key may be agreed. The first computing device 202 includes the device 100 and is, for example, a server or group of servers that provides cloud services. The second computing device 204 is, for example, a mobile phone device. The first computing device 202 and the second computing device 204 are configured to communicate with each other over a communication network 206 or communication link. The communication network 206 may be any suitable communication network, such as the internet. In operation, the first computing device 202 and the second computing device 204 agree the bootstrap key over the network 206 using a specific combination of algorithms designated by a combination scheme.

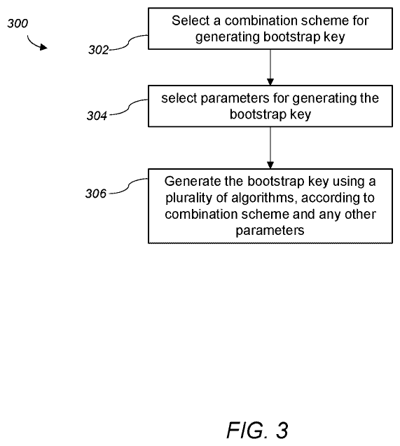

FIG. 3 is a flow diagram that illustrates the process 200 of agreeing a bootstrap key according to various embodiments.

At a first step 302, a combination scheme for agreeing the bootstrap key is selected by the controller 102. The combination scheme may be selected automatically, or by a party for which the bootstrap key is to be agreed. For example, the combination scheme may be selected by the first computing device 202 (the first party) or the second computing device 204 (the second party). In a client-server model, the server is responsible for selecting the combination scheme.

Alternatively, the combination scheme may be selected automatically based on a policy associated with the second party. The policy may be preconfigured and/or adaptable by the first party. The policy could be provided in any suitable form, such as a JavaScript Object Notation (JSON) document including several parameters, an Extensible Markup Language XML file, or the like. The policy may be defined by the server or an administrator thereof. When the server is a cloud-based sever, the policy is actioned by cloud-side APIs in response to a client request. The policy is explained in more detail later.

At a second step 304, the controller 102 is configured to instruct the scheme processing module 104 to agree a bootstrap key according to the selected combination scheme from the first step 302, and according to any parameters. The parameters may be provided in a similar manner to the combination scheme as explained above. The parameters may be provided at the same time as selecting the combination scheme. The parameters may be provided by the first party or automatically based on the policy associated with the second party. The policy may thus designate the number of algorithms to use in the generation of the bootstrap key, the specific algorithms and the order, the length of the bootstrap key and the method to be used to combine them etc. In the client-server model, the server is the first party, and the second party is a device to be bootstrapped to the server. The parameters are determined by the server as required, including which algorithms to use and in what order, for example.

At a third step 306, the scheme processing module 104 is configured to generate and agree a shared bootstrap key between the first and second parties using the plurality of algorithms from the plurality of algorithm modules 106. Using multiple algorithms in this way requires more processing and network overhead between the parties, when compared to using a single algorithm. However, since the purpose of using multiple algorithms is to agree a single key to bootstrap the second computing device 204 when the device is initially registered, relatively slow performance and/or large key sizes are acceptable.

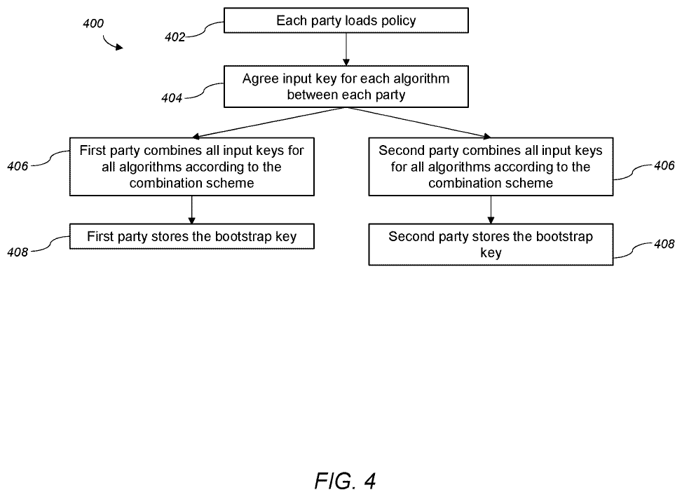

FIG. 4 shows an example of the process 400 that was set out more generally in FIG. 3.

At a first step 402, the parties each require the policy for generating the bootstrap key. The policy is read from a policy database and sent to the client which is being bootstrapped in a preregistration response. The policy includes the combination scheme to be used and any parameters, such as the number of algorithms, the types of algorithms, the order of algorithms, and/or the actual algorithms to be used. When one party is designated as a master, only the master may decide what the policy should be. In the server-client model, the server is the master and dictates the policy. The server may thus send the policy to any second party, such as an end-user device or the like. Alternatively, the first and second parties are two peers. In this instance, the parties could determine what algorithms they both support and agree on the most secure of the overlapping set formed therefrom.

At a second step 404, for each algorithm specified in the policy, the second party initiates a key agreement with the first party to agree an “input key”. The input key is the key generated as a result of a key-exchange for each algorithm. The first and second party agree the input key and cache in it in respective memories of the first and second parties, such that each party has a copy of the input keys.

At a third step 406, each party combines all the input keys from all the algorithms according to the combination scheme defined in policy to create the “output key”, which is the bootstrap key. It is to be understood that, where the combination scheme indicates that the bootstrap key is to be agreed iteratively based on a set of algorithms, the input keys may be combined in the second step 404, such that the input key generated by the first algorithm in the set is used/modified by the second key in the set and so on. In this way, the input key is modified as each algorithm in the set is applied, until a final input key is generated by the final algorithm in the set, wherein the final input key forms the output key.

At a fourth step 408, the first and second parties securely store the bootstrap key associated to memory or a secure storage, such as a Hardware Security Module (HSM) and/or a disk protected by Trusted Platform Module (TPM). In the server-client model, wherein the first party is the server, the first party may store a secure database including this information, for a plurality of second parties (such as different end-user devices).

The second step 404 may be performed in parallel, whereby input keys from each algorithm are agreed concurrently, or in series, whereby input keys are sequentially agreed.

It is to be understood that the third and fourth steps above may be performed at each of the first and second parties concurrently or at different times, since these steps represent processes performed separately at the first and second parties.

The selection of algorithms to use in the combination scheme may vary. It is advantageous to include algorithms that depend on different algorithmic components. In this way, the plurality of algorithms do not share common algorithmic components and thus do not have a shared single point of failure/weakness from an attacker. Known cryptographic algorithms that depend on hard mathematical problems may be used, as well as post-quantum cryptographic algorithms. For example, key exchange mechanisms (KEMs) may be used. These may include Diffie Helmann, Elliptic-curve Diffie Helmann, KYBER, Classic McEliece, FrodoKEM and the like.

The algorithms may be subject to a signature scheme to prevent a man in the middle attack.

It is to be understood that any symmetric-key, cryptographic hash algorithm, or any other suitable algorithm which enable a symmetric key exchange between the first and second party may be used in the plurality of algorithms. As noted above, it is advantageous if at least some of the plurality of algorithms are distinct from each other in terms of the underlying hard mathematical problem or proof upon which they rely.

The combination scheme according to which the algorithms are combined may also vary. The combination scheme may affect whether the bootstrap key is generated in series or in parallel, whether and how each input key from each algorithm is used to generate the bootstrap key. The bootstrap key may be generated by a combination scheme that generates a hash of all input keys, XOR of all keys, or an encryption of a random value which is known to first and second party, by each key in turn. The combination scheme may include a sequence or series of one or more hash functions. For example, a secure hash algorithm such as a Secure Hash Algorithm 3 (SHA-3) may be used to obtain the final symmetric key.

In an example, the combination scheme uses Shamir's Secret Sharing (SSS). SSS can be used to secure a secret S in a distributed way, whereby the secret S is split into multiple parts, called shares Si, which individually do not give any information about the secret. In this example, the secret S is the bootstrap key. In this particular instance the method differs from the description of FIG. 4 as set out above in that the bootstrap key is initially randomly generated with a random number generator. The bootstrap key is then split into several shares S; which are then encrypted using the different algorithms. To unlock the bootstrap key, a minimum number of the shares Si need to be found. This number of shares is referred to as the threshold. Without the threshold number of shares, an adversary cannot obtain the bootstrap key. The threshold is selectable, and may form part of the policy.

An additional advantage of having the threshold below the total number of shares STOTAL is that should one share become lost or corrupted for any reason, the bootstrap key may still be discerned from the remaining shares. However, it is also advantageous if STOTAL is significantly greater than the number of input keys, to maintain the strength and security of the bootstrap key.

Using the combination scheme including SSS together with a diverse set of encryption algorithms, for encrypting the bootstrap key, provides a useful and secure bootstrap key. Furthermore, this combination scheme is relatively efficient in that the size of each share S; does not exceed the original data. Furthermore, SSS is adjustable in that shares can be dynamically added/deleted, since calculating new points on the underlying polynomial does not affect previously calculated points that form the existing shares. SSS can also be enhanced or refreshed regularly without changing the bootstrap key, by changing the polynomial and constructing new shares Sᵢ.

Using SSS, the shares Sᵢ may be encrypted by each different algorithm in series or in parallel.

It is to be understood that the number of shares Sᵢ may be selected by the policy, together with the threshold. The number of shares Sᵢ may be 2, 3, 4, 5, 10 or more shares for example.

When using SSS, the bootstrap key is predetermined, split into shares, and then encrypted with the plurality of algorithms. The encrypted shares are calculated by one party, and are then transmitted to the other party, which also has the input keys used to encrypt the shares. The other party can then decrypt each share using the appropriate input key and therefore recover the bootstrap key.

In other embodiments, the bootstrap key is not predetermined and is thus not pre-known to either of the first or second party. In this case, the bootstrap key depends on the order of operations. The input keys are exchanged between the first and second parties and subsequently combined in a specific operation to form the bootstrap key. The specific operation could be sequential encryption of a random value, or encryption of the previous key with the next, for example. In this case, to break the bootstrap key, an attacker would have to attack each algorithm in the order in which they were used. For example, a first key may be encrypted with a second key, the result of which could then be encrypted with a third key, the result of which could be encrypted with a fourth key and so on.

Alternatively, the parties may share a public nonce, which is encrypted with the first key, the result of which is encrypted with a second key and so on.

The algorithms and/or the combination scheme may be selected based on a policy, as set out above. The policy, and its interaction with the first and second party, will now be explained here in more detail.

The policy includes an indication of one or more of: the combination scheme to be used to generate the bootstrap key, any constraints of the combination scheme, such as the threshold and number of shares for SSS as described above, and the parameters relating to the bootstrap key, such as the length of the bootstrap key, the number of algorithms, the type of algorithms, the diversity of the algorithms, the ordering of the algorithms in generating the bootstrap key and/or the specific algorithms to be used.

The policy may be selected by the first party, and a copy sent to the second party. There may be a registration process whereby the first party registers with the second party. For example, the second party may be an end user device, and may attempt to register with the first party, which may be a server providing cloud services. There may be a quantum cloud registration process. At the time of registration, or thereafter, the policy can be either assigned by the second party, the first party, or agreed mutually. In one example of the client-server model, the client device is the second party and the server is the first party. The client device connects to or calls into the server, the server checks the policy and starts n key agreements according to the policy, where n is a positive real integer. The response from the server contains the public parts of those key agreements in order. The client device receives the policy, and then performs the next stage of the key agreements for each of the n key agreements. The client device then posts the final public part of each key agreement in order to the server. The client device and server now have the n agreed keys, and can now combine them to form the bootstrap key.

The policy may be predetermined by the first party (the server). In particular, the first party may set one or more policies, from which the second party may choose the most appropriate policy for them. The second party may not be previously known to the first party and thus may be considered as an uncontrolled device by the first party. In this respect, the second party may take the form of a variety of computing devices, with, for example, different processing capabilities, memory, and other technical constraints. The first party may thus provide a plurality of policies that suit different types of devices or technical constraints. For example, a first policy may include the use of 2 algorithms to generate the bootstrap key, a second policy may include the use of 3 algorithms to generate the bootstrap key, and a third policy may include the use of 4 or more algorithms to generate the bootstrap key. It is to be understood that these three policies are exemplary and additional parameters may also change between policies. The first policy has fewer algorithms than the second and third policies so may be considered less secure. However, the first policy may have less memory requirements to run. Thus, policies can be selected by the first or second party based on at least one of a desired security level and technical constraints.

The policies may be formed according to the technical capabilities of specific devices, such that the first party stores a plurality of policies for different devices and/or agrees a policy with the second party based on the device to which the second party corresponds.

The first party may maintain a database of policies for different devices, and may update existing policies with new policies when a new device is encountered for the first time. The first party may further store a database including available algorithms to generate the bootstrap key with. Each algorithm may be associated in the database with an indication regarding the underlying mathematical problem, proof or other underlying concept on which the algorithm runs. In this way, the diversity of algorithms selected can be ensured, by automatically selecting algorithms that are diverse and fit within the desired policy. For example, where the policy indicates that 2 algorithms are to be used, the first or first party may automatically select, from the database, 2 algorithms that are diverse according to their associated indication. Effectively, for each policy, the database allows the first or second party to select at least two diverse algorithms, with the potential for more diversity as the policy allows more algorithms. The database, registration process, and automatic selection of algorithms may be enacted by the controller 102 of the device 100 that forms at least part of the first device 202. In this way, the device 100 represents an automated bootstrap calculator that automatically generates a bootstrap key using a plurality of diverse algorithms, and that fits requirements of an external device (the second party) as set out in a policy.

In one example, the algorithms may be selected automatically based on the requirements or constraints of the second party. For example, the algorithms themselves and the number of algorithms may be selected automatically on the basis of the memory, power and computational capabilities of the second party. The policy may thus be adapted based on the computational characteristics of the second party.

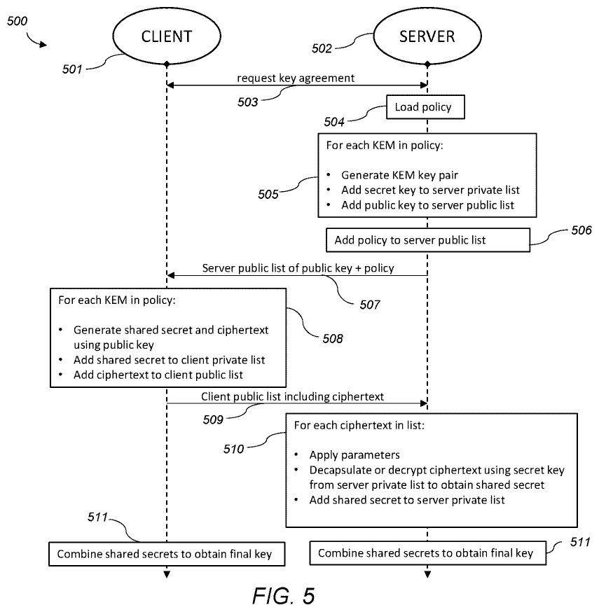

FIG. 5 shows a flow diagram 500 of an example key agreement according to various embodiments, using the policy. The flow diagram shows the actions performed by each of a client 501 and a server 502, although it is to be understood that the server 502 may be any first party as described above and the client 501 may be any second party as described above. The client 501 and the server 502 each maintain two ‘lists’. The lists may take the form of a database, or any other data entry that may be recorded to memory. At the client 501, a client private list and a client public list are maintained. The client private list may not be shared with other parties such as the server 502. The client public list may be shared with other parties such as the server 502. At the server 502, a server private list and a server public list are maintained. The server private list may not be shared with other parties such as the client 501. The server public list may be shared with other parties such as the client 501.

In a first step 503, a key agreement is requested by either or both of the client 501 and the server 502. This request may take any suitable form and notify each party that key agreement should start.

In a second step 504, the policy is loaded by the server 502. The policy may be a specific policy associated with the client 501, or the type of device the client 501 is, for example. As discussed above, the policy includes information including parameters to be used in the key exchange.

In a third step 505, for each key exchange algorithm or key encapsulation mechanism in the policy, the server 502 applies the parameters of the policy to the key exchange method and begins the process of generating public and secret key pairs at the server side. The server secret key is added to the server private list, and the server public key is added to the server public list.

In a fourth step 506, details regarding the policy are added to the server public list at the server side.

In a fifth step 507, the server public list of public keys used by the server are sent with the details regarding the policy used from the server 502 to the client 501. The client 501 thus receives the policy if it is not already known to the client 501.

In a sixth step 508, the client 501 uses the policy to obtain the necessary parameters (such as types of algorithm to use) and generates a shared secret key and a cipher text accordingly, for each key exchange algorithm or key encapsulation mechanism in the policy. The shared secret is added to the client private list at the client side and the cipher text is added to the client public list at the client side.

In a sixth step 509, the client 501 sends to the server 502 the contents of the client public list including the cipher text, for each algorithm/mechanism used.

In a seventh step 510, at the server 502, the cipher text received from the client 501 is used together with any necessary parameters of the policy to obtain the shared secret, using the server's secret key. The shared secret is then added to the server private list at the server side.

In an eighth step 511, the shared secrets are independently combined at each of the client and server side, from their respective private lists, to obtain the final key. The final key may be the bootstrap key in this example.

In the embodiments described above, the server may comprise a single server or network of servers. In some examples, the functionality of the server may be provided by a network of servers distributed across a geographical area, such as a worldwide distributed network of servers, and a user may be connected to an appropriate one of the network servers based upon, for example, a user location.

The above description discusses embodiments of the invention with reference to a single second device, and second party, for clarity. It will be understood that in practice the system of the second device and the first device may be shared with a plurality of such second devices, and possibly by a very large number of users associated with such devices simultaneously. Thus, the first party and first device may manage and generate multiple bootstrap keys for multiple second devices (multiple second parties)

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and Blu-ray®) disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fibre optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Program-specific Integrated Circuits (ASICs), Program-specific Standard Products (ASSPs), System-on-a-chip systems (SOCs). Complex Programmable Logic Devices (CPLDs), etc.

Although illustrated as a single system, it is to be understood that the computing devices described here may be a distributed system. Thus, for instance, several devices may be in communication by way of a network connection and may collectively perform tasks described as being performed by the computing device.

The term ‘computer’ is used herein to refer to any device with processing capability such that it can execute instructions. Those skilled in the art will realise that such processing capabilities are incorporated into many different devices and therefore the term ‘computer’ includes PCS, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1-21. (canceled)

22. A computer-implemented method of agreeing a final symmetric key between a first party and a second party, wherein the first party is configured to communicate with the second party, the method comprising:
retrieving a plurality of key exchange algorithms or key encapsulation mechanisms wherein the plurality of key exchange algorithms or key encapsulation mechanisms are each different;
agreeing a set of keys using the plurality of key exchange algorithms or key encapsulation mechanisms;
using the agreed set of keys to obtain a final symmetric key, according to a combination scheme that specifies how each key of the set of keys is to be used to obtain the final symmetric key; and
storing the final symmetric key at the first and second party.

23. The method of claim 22, wherein the combination scheme is Shamir's Secret Sharing scheme, such that obtaining the final symmetric key comprises:
at the first party:
generating the final symmetric key;
splitting the final symmetric key into a plurality of shares;
encrypting each share with a key of the agreed set of keys;
transmitting each encrypted share to the second party;
and at the second party:
decrypting each encrypted share with a respective key of the set of agreed keys;
combining all or some of the decrypted shares to obtain the final symmetric key.

24. The method of claim 22, wherein the combination scheme is an exclusive or scheme, XOR, such that the method comprises:
performing an XOR operation on the agreed set of keys to obtain the final symmetric key.

25. The method of claim 22, wherein the combination scheme is a sequential encryption scheme, such that the method comprises:
performing sequential encryption using the agreed set of keys, in a specific order, to obtain the final symmetric key.

26. The method of claim 22, wherein the plurality of key exchange algorithms or key encapsulation mechanisms include classical cryptographic algorithms.

27. The method of claim 22, wherein the plurality of key exchange algorithms or key encapsulation mechanisms include post-quantum cryptographic algorithms.

28. The method of claim 22, further comprising retrieving a policy, wherein the policy includes information indicative of parameters to be used for obtaining the final symmetric key, the parameters including at least one of:
a number of key exchange algorithms or key encapsulation mechanisms to use to obtain the final symmetric key;
a type of key exchange algorithm or key encapsulation mechanism to use to generate the final symmetric key;
specific algorithms or mechanisms of the plurality of key exchange algorithms or key encapsulation mechanisms to use to generate the final symmetric key;
an ordering of the specific algorithms or mechanisms to use to generate the final symmetric key;
a key length for generating the final symmetric key;
the combination scheme to use to generate the final symmetric key; and
whether the final symmetric key is to be generated in series or parallel;
the method further comprising:
generating the final symmetric key using the parameters included in the policy.

29. The method of claim 28, further comprising:
agreeing the policy between the first and second party; or
sending the policy from the first party to the second party; or
sending the policy from the second party to the first party.

30. The method of claim 28, when dependent on claim 2, wherein the policy comprises at least one of:
a number of shares to divide the final symmetric key between; and
a threshold number of shares required to reconstruct the final symmetric key.

31. The method of claim 28, wherein the parameters of the policy are set based on technical constraints of the first party and/or the second party.

32. The method of claim 31, wherein the technical constraints include at least one of:
a memory availability;
a measure of processing power;
a time limit for performing the agreeing the set of keys and
a bandwidth in a communication channel.

33. The method of claim 22, wherein the plurality of key exchange algorithms include at least two algorithms that are diverse, wherein the diverse algorithms rely on different mathematical problems or underlying concepts.

34. The method of claim 33, wherein obtaining the final symmetric key includes selecting at least the two diverse algorithms from the plurality of algorithms.

35. The method of claim 33, further comprising:
maintaining, at the first party, a database including the plurality of key exchange algorithms, wherein each key exchange algorithm in the database is associated with information indicative of the concept on which the key exchange algorithm is based;
the method further comprising:
retrieving, from the database, two or more key exchange algorithms based on the associated information for the two or more key exchange algorithms being diverse with respect to the concept on which they are based.

36. The method of claim 22, wherein the final symmetric key is one of:
a bootstrap key;
an authentication key; or
a data encryption key.

37. A system comprising:
a first computer device having memory and a processor; and
a second computer device having memory and a processor;
wherein the first computer device and the second computer device are configured to communicate with each other, wherein the first computer device is a first party and the second computer device is a second party, and wherein the system is configured to execute the method according to claim 22.

38. The system of claim 37, wherein the first computer device is a server and the second computer device is a user terminal device.

39. A computing device configured to communicate with one or more external computing devices, the computer device comprising a processor and memory, the memory having instructions stored thereon, which, when executed, cause the processor to:
retrieve a plurality of key exchange algorithms or key encapsulation mechanisms, wherein the plurality of key exchange algorithms or key encapsulation mechanisms are each different;
agree, with a second computing device of the one or more external computing devices, a set of keys using a plurality of key exchange algorithms or key encapsulation mechanisms;
use the agreed set of keys to obtain a final symmetric key, according to a combination scheme that specifies how each key of the set of keys is to be used to obtain the final symmetric key; and
store the final symmetric key to memory.

40. The computing device of claim 39, wherein the computing device is configured to communicate with the second computing device to agree a policy with the second computing device, wherein the policy includes information indicative of parameters to be used for generating the final symmetric key, the parameters including at least one of:
a number of key exchange algorithms or key encapsulation mechanisms to use to generate the final symmetric key;
a type of key exchange algorithm or key encapsulation mechanism to use to generate the final symmetric key;
specific algorithms or encapsulation mechanisms of the plurality of key exchange algorithms or key encapsulation mechanisms to use to generate the final symmetric key;
an ordering of the specific algorithms or encapsulation mechanisms to use to generate the final symmetric key;
a key length for generating the final symmetric key;
the combination scheme to use to generate the final symmetric key; and
whether the final symmetric key is to be generated in series or parallel;
wherein the computing device is configured to
generate the final symmetric key using the parameters included in the policy.

41. The computing device of claim 39, wherein the computing device is configured to combine the key exchange algorithms according to a Shamir's secret sharing combination scheme, wherein the computing device is configured to automatically select two or more of the plurality of key exchange algorithms based on their relative diversity in underlying concept.
